(19) United States
(12) Patent Application Publication
(10) Pub. No.: US 2006/0083514 A1
(43) Pub. Date: Apr. 20, 2006

(54) Bi-directional OADM module and solution for the optical access network

(75) Inventors: Wen Liu, Hubei (CN); Cuiqing Liu, Hubei (CN); Xuguang Dong, Hubei (CN); Qinghua Liang, Hubei (CN); Xiaotao Zhang, Hubei (CN)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Accelink Technologies Co., Ltd.

(21) Appl. No.: 11/073,530

(22) Filed: Mar. 7, 2005

(30) Foreign Application Priority Data
Mar. 8, 2004 (CN) 200410012824.7

(51) Int. Cl. H04J 14/02

(52) U.S. Cl. 398/85

(57) ABSTRACT

The invention discloses a bidirectional OADM device, comprising a main body, on which a first fiber ferrule, a first filter, a Lens, a second filter, a second fiber ferrule arranged along a transverse optical axis of the device, and a Laser and a Pin-TIA vertical to the transverse optical axis, wherein the Laser and the Pin-TIA are located at either the same side or at each side of the transverse optical axis, respectively, and the normal of Laser and the first filter intersect with each other in an angle of about 45 degree, the normal of Pin-TIA and the second filter intersect with each other in an angle of about 45 degree, and the first filter offers total reflection to an optical signal transmitted by the Laser and gives total transmission of an received optical signal into Pin-TIA and an CATV signal, the second filter offers total reflection to an optical signal received by Pin-TIA and gives total transmission of CATV signal.

### FIELD OF THE INVENTION

The present invention relates to video, voice, and data communications. More particularly, the present invention relates to an OADM (Optical add and drop Multiplexer) device used in fiber-to-the-home (FTTH) network, which can be installed in the User's end or the office end.

### BACKGROUND OF THE INVENTION

Optical access network (OAN) by the way of FTTH is a fundamental approach to satisfy User's demand for wide band solutions. To reduce construction cost of OAN, a large number of single-fiber bi-directional devices are used in the network for providing high-speed services in respect of Data, Voice and CATV.

A typical Point to Point (P2P) fiber optical network for FTTH, that is a three-wavelength optical network is shown in FIG. 1. This optical network is comprised of CATV(A), EDFA(B), SPLITTER(C), BIDI(Bi-Directional transceiver, D) and WDM (Wavelength Division Multiplexer, E). In the optical network, an optical signal λ3 for CATV (A) end is amplified and output by EDFA (Erbium-Doped Fiber Amplifier, B). The amplified optical signal M output from EDFA(B) is distributed by a SPLITTER(C) at office end, then combined with an optical signal of BIDI(D) by a WDM(E). The combined signal is transmitted to User's end. The optical signal λ1 transmitted from User's end and the optical signal λ2 transmitted from the office end will be processed by BIDI (D) separately. It is clearly shown in the typical optical network that besides a BIDI (D), there still need a WDM (E) to combine the optical signal λ1 transmitted from User's end, the optical signal λ2 transmitted from office end and the optical signal from CATV (A).

The typical operation of a bi-directional device-BIDI for office end is shown in FIG. 2. BIDI (D) is comprised of an optical collimator (pin) 1, a Laser 2, a Pin-TIA 3, a wavelength filter 4, a spherical Lens 4 and a spherical Lens 7. An optical signal λ2 transmitted from Laser 2 at office end passes through a wavelength filter 4 which is inclined in an angle of about 45 degree, then the spherical Lens 7 for coupling into the fiber-optical collimator (pin) 1 and is sent to User's end finally. The optical signal λ1 transmitted from the User's end passes through fiber-optical collimator (pin) 1, spherical Lens 7, and is reflected by wavelength filter 4 before enters into Pin-TIA 3.

As above described, there are two ports for the fiber-optical communication line with one for data and voice signal and the other for CATV system. A multiplexer is needed for these signals of voice and CATV and data to combine the wavelength and transmit them through a single optical fiber. Adding an extra WDM (E) not only increases the system cost but also makes the work of installation and commissioning complicated.

At the User's end, typically there are two kinds of devices, that is, a device with two ports and a device with three ports, the operation thereof are shown in FIG. 3 and FIG. 4, respectively. FIG. 3 illustrates a simplified tow-port device. An optical signal λ2 transmitted from office end passes through a collimator (pin) 1, a spherical Lens 7 and a filter 4 successively, then is reflected into Pin-TIA 3. An optical signal λ1 transmitted from Laser 2 at the User's end passes through a filter 4 and the spherical Lens 7 for coupling into the fiber-optical collimator (pin) 1 and is sent to the office end finally. FIG. 4 illustrates a simplified three-port device. An optical signal λ2 transmitted from office end passes through a collimator (pin) 1, a spherical Lens 7, a filter 4a, a filter 4b successively, then reflected into Pin-TIA 3. An optical signal λ1 transmitted from Laser 2 at the User's end passes through a filter 4b, a filter 4a and the spherical Lens 7 successively for coupling into the fiber-optical collimator (pin) 1. An optical signal λ3 transmitted from Office end passes through a collimator (pin) 1 and a spherical Lens 7, then passing through the filter 4a to be reflected into the detector 8.

The difference between the two-port and three-port devices is that the two-port device processes only the data and voice signal without CATV signal processing ability. The two-port device has already been used in a system that transmits data and voice signal only. At the same time, there are also many single fiber-optical CATV modules operating in the system. Along with the progress of network, cost will be a big issue for the upgrade from two-port device to three-port device when it requires incorporating CATV, data and voice signal into one system. As for three-port device, which is endued with receiving function of CATV signal, the CATV port is a waste to be installed in some legacy systems where the CATV signal already there.

Accordingly, there is a need in the art for the equipment supplier to provide a kind of universal device and network solution, which provide simplicity. At the same time, there is always a need in the art for the equipment supplier to provide a device with a low cost, as well as easy for installation and maintenance. An additional need existing in the art for service supplier is on the upgrade ability and mutual replacement ability among the different supplier's equipments.

### SUMMARY OF THE INVENTION

The present invention is directed to addressing the problems and needs set forth above.

According to the present invention, a bidirectional OADM device is provided, comprising: a main body, on which a removable first fiber ferrule, a first filter, a Lens, a second filter, a removable second fiber ferrule arranged along a transverse optical axis of the device, and a Laser and a Pin-TIA vertical to the transverse optical axis, wherein the Laser and the Pin-TIA are located at either the same side or at each side of the transverse optical axis, respectively, and the normal of Laser and the first filter intersect with each other in an angle of about 45 degree, the normal of Pin-TIA and the second filter intersect with each other in an angle of about 45 degree, and wherein the first filter offers total reflection to an optical signal transmitted by the Laser and gives total transmission of an received optical signal received by Pin-TIA and an CATV signal, the second filter offers total reflection to an optical signal received by Pin-TIA and gives total transmission of CATV signal.

Moreover, the OADM device according to the present invention may further comprise a third filter arranged in front of the Pin-TIA with an angle about 8 degree with respect to a the transverse direction, said third filter gives total transmission of optical signal received by the Pin-TIA and offers total reflection to the other optical signal.

Further, according to the present invention, an optical access network is provided, comprising: a CATV end for receiving a CATV signal; an EDFA for amplifying the CATV signal received from the CATV end; a splitter for distributing the amplified signal from the EDFA; and the OADM device according to present invention.

### BRIEF DESCRIPTION OF THE DRAWINGS

The present invention will become apparent from the following description of embodiments with reference to the accompanying drawing, in which like reference numbers denote like elements.

FIG. 1 is the working principle diagram of a typical three-wavelength fiber-optical (P2P) network;

FIG. 2 is the working principle diagram of BIDI, a transmitter and receiver combined device;

FIG. 3 illustrates a conventional of 2-port device at User's port;

FIG. 4 illustrates a conventional 3-port device at User's port;

FIG. 5 illustrates the structure of the OADM device according to one embodiments of the present invention;

FIG. 6 illustrates the structure of the OADM device according to another embodiments of the present invention;

FIG. 7 illustrates optical channel of the OADM device according to the present invention;

FIG. 8 illustrates generation of crosstalk among the devices in a two-wavelength bi-directional network;

FIG. 9 illustrates a (two) three wavelength FTTX network according to the embodiment of the present invention.

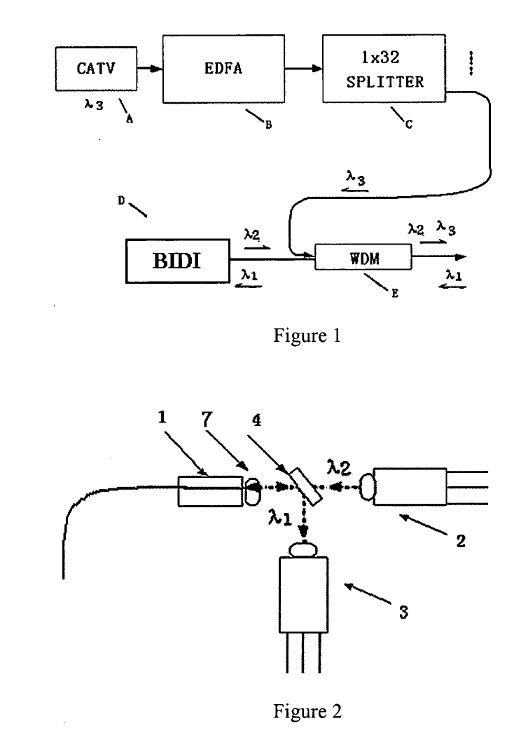

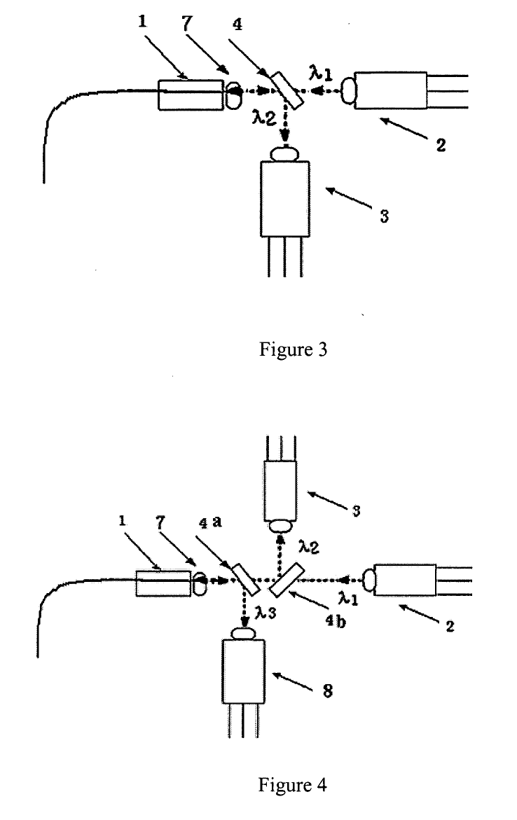

In the drawings:
A-Signal of CATV;
B-Erbium-doped fiber amplifier;
C-Splitter;
D-Bidirectional transmitter-receiver;
E-WDM;
F-Three-wavelength OADM;
0-Main body;
1-1b: Fiber ferrule including first fiber ferrule 1a and second fiber ferrule 1b;
2-Laser;
3-Pin-TIA;
4-Filter including first filter 4a, second filter 4b and third filter 4c;
5-Lens;
6-Hollow cavity;
7-Spherical Lens;
8-Detector;
λ1-Wavelength of optical signal received at Office end and that transmitted from User's end;
λ2-Wavelength of optical signal transmitted from Office end and that received by User's end;
λ3-Wavelength of optical signal of CATV.

### DETAILED DESCRIPTION OF EMBODIMENTS

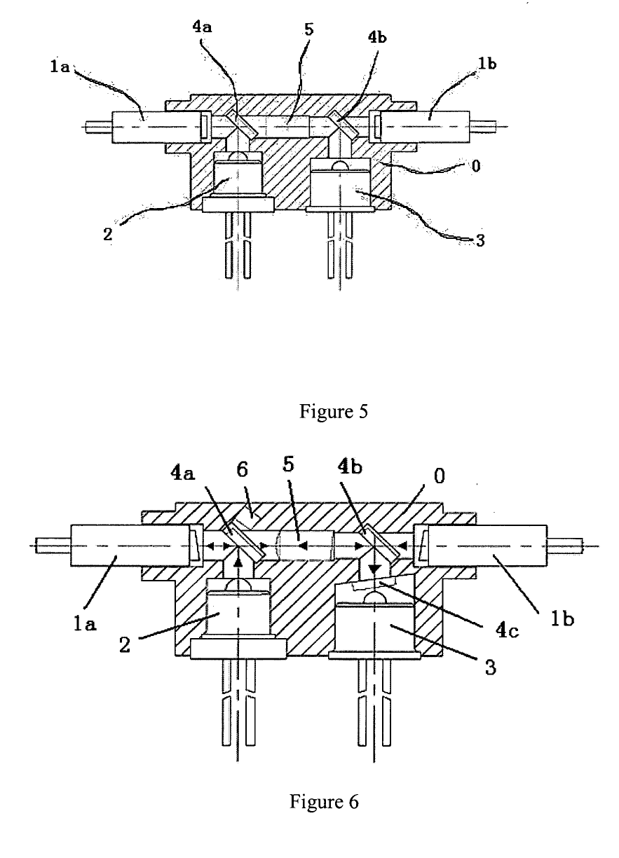

The OADM device according to one embodiments of the present invention is as shown in FIG. 5.

As shown in FIG. 5, the OADM device according to the present invention is comprised of a first fiber ferrule 1a, a first filter 4a, a Lens 5, a second filter 4b, a second fiber ferrule 1b, a Laser 2, a Pin-TIA 3.

On the main body 0 of the OADM device according to the present invention, arranged from left to right along the transverse optical axis are the first fiber ferrule 1a, the first filter 4a, the Lens 5, the second filter 4b and the second fiber ferrule 1b. The Laser 2 and the Pin-TIA 3 that are vertical to the transverse optical axis are located at either the same side or at each side of the transverse optical axis, respectively. The normals of Laser 2 and the first filter 4a intersect with each other in an angle of about 45 degree. The normals of Pin-TIA 3 and the second filter 4b intersect with each other in an angle of about 45 degree.

The OADM device according to the second embodiments of the present invention is as shown in FIG. 6. In this embodiment, a third filter 4c is provided in the OADM device. The insertion of the third filter 4c may increase the isolation of port Pin-TIA 3 from other optical signals (λ2 at Office end, λ1 at the User's end and λ3 of CATV) and hence reduces the crosstalk. In addition, the third filter 4c may have an inclination angle to increases return loss of the device.

As shown in FIG. 6, the OADM device according to the present invention is comprised of a first fiber ferrule 1a, a first filter 4a, a Lens 5, a second filter 4b, a second fiber ferrule 1b, a Laser 2, a Pin-TIA 3, and a third filter 4c.

On the main body 0 of the OADM device according to the present invention, arranged from left to right along the transverse optical axis are the first fiber ferrule 1a, the first filter 4a, the Lens 5, the second filter 4b and the second fiber ferrule 1b. The Laser 2 and the Pin-TIA 3 that are vertical to the transverse optical axis are located at either the same side or at each side of the transverse optical axis, respectively. The third filter is arranged in front of Pin-TIA 3. The normal of Laser 2 and the first filter 4a intersect with each other in 45 degree. The normal of Pin-TIA 3 and the second filter 4b intersect with each other in 45 degree. The third filter 4c is provided with an angle about 8-degree with respect to the transverse direction.

Preferably, there is a cavity 6 on the main body 0 at back of the first filter 4a, which is filled (coated) with absorbance material. The first fiber ferrule 1a and the second fiber ferrule 1b can be attached onto the main body 0 with the structure of plug-and-pull type or coupling into a fiber pigtail.

The first filter 4a is a filter offering total reflection to the optical signal transmitted by Laser 2 and gives total transmission of the received optical signal (λ1 at Office end, λ2 at User's end) by Pin-TIA 3 and CATV signal λ3.

The second filter 4b is a filter offering total reflection to the optical signal (λ1 at Office end, λ2 at User's end) received by Pin-TIA 3 and gives total transmission of CATV signal λ3.

The third filter 4c is a filter offering total reflection to the optical signal (λ1 at Office end, λ2 at User's end) received by Pin-TIA 3 and gives total transmission of the other optical signal (i.e., λ2 at Office end, λ1 at User's end, and CATV signal λ3)

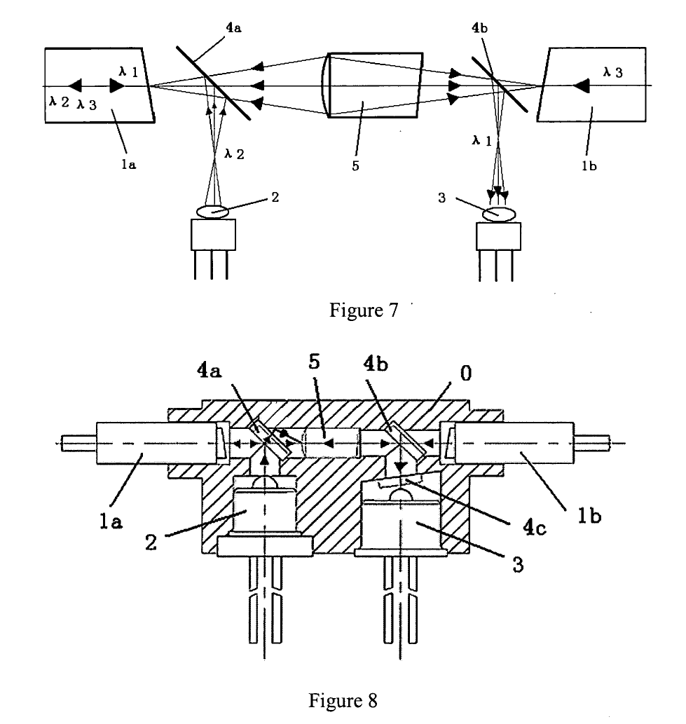

The operation of the OADM device according to the present invention will be described with reference to FIGS. 6 and 7.

In an application in Office end, the optical signal λ1 sent out from the User's end enters the OADM device through the first fiber ferrule 1a. The entered optical signal λ1 passes through the first filter 4a, Lens 5 successively, and is reflected by the second filter 4b. The reflected optical signal passes through the third filter 4c, then enters into Pin-TIA 3 to be processed by Office end;

An electrical signal from Office end is converted into optical signal λ2 through Laser 2. The optical signal λ2 is reflected by the first filter 4a then coupled into the first fiber ferrule 1a to be transmitted to Users.

An optical signal λ3 of CATV passes through the second fiber ferrule 1b, the second filter 4b, the Lens 5 and the first filter 4a successively, and then is coupled into the first fiber ferrule 1a to be transmitted to Users.

The second fiber ferrule 1b can be constructed in plug-and-pull type or coupling into a fiber pigtail, which is ready for CATV system signal plug-in directly. This second fiber ferrule 1b can be set vacant in case that the CATV port doesn't need at beginning, but is kept for future upgrade.

In an application in User's end, an electrical signal from the User's end is converted into an optical signal λ1 through Laser 2. The optical signal λ1 is reflected by the first filter 4a and coupled into the fiber ferrule 1a and transmitted to Office end.

An optical signal λ2 transmitted from Office end passes through the first fiber ferrule 1a and enters into the OADM device. The entered optical signal λ2 passes through filter 4a and Lens 5, and is reflected at the second filter 4b. The reflected optical signal is filtered by the third filter 4c, and the filtered optical signal enters into Pin-TIA 3 to be processed by the User.

An optical signal λ3 of CATV goes through the first fiber ferrule 1a, the first filter 4a, the Lens 5, the second filter 4b successively, and is coupled into the second fiber ferrule 1b and is to be processed by a CATV signal processor.

The second fiber ferrule 1b can be constructed in plug-and-pull type. In case that legacy CATV system is already set beforehand, the second fiber ferrule 1b is ready for plug-in directly, so that no additional fiber need to be installed. In other word, this OADM module is universal to deploy, even if the legacy CATV system already there or the CATV port doesn't need at beginning, but is kept for future upgrade.

Preferably, filter 4 may be coated dependent on the specific application in an optical system.

Particularly, the face of the first filter 4a facing the end of Laser 2 is coated with band rejection window for the optical signal from Laser end (λ2 from Office end, λ1 from the User's end), the other face is coated with antireflective film in conformity with optical signal λ3 of CATV and received optical signal of Pin-TIA 3 (λ1 into Office end, λ2 into the User's end).

The face of the second filter 4b facing the end of Pin-TIA 3 is coated with band rejection window for the received optical signal into Pin-TIA 3 end (λ1 at Office end, λ2 at User's end ), the other face is coated with antireflective film in conformity with optical signal λ3 of CATV.

The face of the third filter 4c facing the end of Pin-TIA 3 is coated with a antireflective film for the received optical signal from Pin-TIA 3 end (λ1 into Office end, λ2 into the User's end) and the other face is coated with the reflection film for other optical signal (λ2 from Office end, λ1 from the User's end and λ3 from CATV end).

Insertion of the third filter 4c may increase the isolation of port Pin-TIA 3 from other optical signals (λ2 from Office end, λ1 from the User's end and λ3 of CATV) and hence reduces the crosstalk. The inclined angle of about 8 degree increases return loss of the device.

The Lens 5 is deployed between the fiber ferrule 1a and fiber ferrule 1b, taking Office end as an example, to focalize the optical signal λ3 sent out from the optical-fiber pin 1b onto the fiber ferrule 1a by way of imaging method, as shown in FIG. 7. The well-designed Lens 5 can optimize numerical aperture of the fiber ferrule 1b that are imaged after going through it. It can keep relatively large distance between the optical-fiber pin 1a and 1b and achieves high efficiency in coupling also at the same time. In FIG. 7, the side of Lens 5 that is close to the fiber ferrule 1b is configured to keep a certain inclination angle with respect to the vertical direction in order to correct the inclination of light beam resulted from the inclined end of fiber ferrule 1b, which increases margin in overall assembly of the device and ensure its return loss as well.

The operation of the OADM device according to the present invention in the User's end is the same as that in Office end.

The optical Lens 5 adopted here is either of a C-Lens or a G-lens with gradual-change refractive index. The Lens 5 can be made of LASFN9 glass or BK7 glass, or SF6 glass or SF11 glass with its shape in round column or square column. Whatever column it is, one side of the column is spherical surface and the other side is inclined surface.

To improve the return loss and reduce the loss of optical signal on each optical faces due to the Fresnel reflection, the end surface of fiber ferrules 1a and 1b can be an inclined surface with an angle of 6°-10° with respect to the vertical direction. In order to make the principal axis of outgoing light beam in parallel with light axis of Lens 5, an angle of 4°-8° is kept between the inclined surface of Lens 5 and the vertical direction. An antireflective film is coated on both end surfaces of Lens 5 and end surfaces of fiber ferrule 1a and 1b with wavelengths change in adapt to various practices.

By properly arranging the insertion locations of filter 4a and 4b, it can be ensured that light transmitted out from Laser 2 (λ2 from Office end, λ1 from the User's end) is coupled into the fiber ferrule 1a after it is reflected by the first filter 4a. The optical signal (λ1 into Office end, λ2 into the User's end) enters into the OADM device through the fiber ferrule 1a, and is coupled into Pin-TIA 3 after it is reflected by the second filter 4b.

Generally, the FTTH system operates under three-wavelength condition. There still exists another working condition for a two-wavelength, that is, the optical signal transmitted from Laser at Office end and the one from Laser at User's end are in same wavelength, namely λ1=λ2. In the case, the light emitted from the Laser will enter into Pin-TIA even in a conventional BIDI(D) and produce great crosstalk. As shown in FIG. 8, part of the optical signal emitted from Laser 2 is reflected by the filter 4a and the reflected optical signal is coupled into the fiber ferrule 1a, and the other part of the optical signal transmits the filter 4a to be reflected by the backside of filter 4a and then mixed with the optical signal from User's end before it goes into Pin-TIA 3 and produces crosstalk.

In the OADM device according to the present invention, a cavity is set on the main body 0 at the back of the filter 4a, which is filled (applied) with absorbance material to absorb certain wavelength, particularly the light from Laser 2 in this embodiment. Thus, the light from Laser 2 passes through the filter 4a and enters into the cavity, and becomes trailed off or faded away after being reflected and absorbed for several times so that the resulted light can not enter into Pin-TIA 3. As a result, the influence of crosstalk exerted by Laser 2 on Pin-TIA 3 is decreased.

As above described, the OADM module according to the present invention can be used in both the Office end and the User's end, although the laser 2 wavelength and the filter 4(a-c) spectrum are different for different end. This will be a benefit for the manufacturer to control the production cost.

In addition, when the OADM device according to the present invention is used in Office end, it features both single fiber bidirectional module and WDM functions, that is, it can process data, voice signal directly and can combine data, voice signal and CATV signal directly without the need of an additional WDM device. As a result, the system structure is simplified and the cost is reduced.

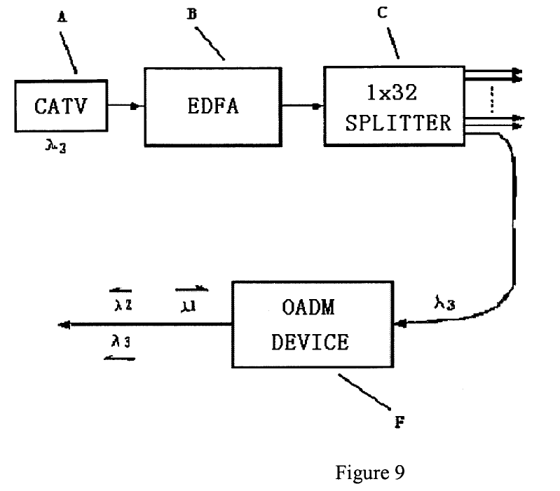

FIG. 9 illustrates a (two) three wavelength FTTX network according to the embodiment of the present invention. As shown in FIG. 9, the CATV(A) optical signal λ3 distributed by SPLITTER(C) enters the OADM device (F) according to the present invention and is transmitted directly to User together with the optical signal λ2 from Office end. The optical signal λ1 from User enters into the OADM device (F) through the same optical fiber to be processed by Office end. A plug-and-pull structure can be adopted for the fiber ferrule (but also OK to be a fiber pigtail), which is ready for CATV signal plug-in directly. And it also can be taken off in case that the CATV port doesn't need at beginning, but kept for future upgrade.

When the OADM device according to the present invention is used in User end, it can process data and voice signal directly, and can separate a CATV signal from the others to be processed by an existing CATV or separate CATV signal processor. A plug-and-pull structure can be adopted for fiber ferrule, which can be taken off in case of no process of CATV signal. This connection of the fiber ferrule is similar to that of fiber connector core, which is in convenience for application.

As describe above, in term of optical performance, the Lens 5 is used as an optical coupling element. The inclination of light beam resulted from inclination of the end surface of the fiber ferrule 1 can be corrected by proper designs of Lens 5 in terms of material, length, curvature of curved surface and the angle between the inclined surface and the vertical direction. With this design, it can improve quality of light beam, increase coupling distance, improve margin for coupling assembly and guarantee the return loss of overall device as well.

In addition, it can increase isolation at Pin-TIA 3 end and to increase the return loss by arranging the filter 4c in an inclined position.

By providing the hollow cavity 6 on the main body at back of the filter 4a, inside of which is filled (applied) with absorbance material, it can absorb the light from Laser 2 that goes through the filter 4a, make the light unable to be reflected into the Pin-TIA 3 so that crosstalk of the device is reduced.

In addition, it facilitates soldering an element in PCB by installing Laser 2 and Pin-TIA 3 on the same side of transverse axis.

The preferred embodiments described herein are illustrative and not restrictive, and the modification and variations may be made without departing from the spirit of the invention. The scope of the invention is defined by the appended claims.

The present invention claims the benefit of Chinese Patent Application No. 200410112804.7, filed on Mar. 8, 2004, the disclosure of which is incorporated herein by reference in its entirety.

That which is claimed is:

1. A bidirectional OADM device, comprising a main body, on which a first fiber ferrule, a first filter, a Lens, a second filter, a second fiber ferrule arranged along a transverse optical axis of the device, and a Laser and a Pin-TIA vertical to the transverse optical axis,
wherein the Laser and the Pin-TIA are located at the same side of the transverse optical axis, respectively, and the normal of Laser and the first filter intersect with each other in an angle of about 45 degree, the normal of Pin-TIA and the second filter intersect with each other in an angle of about 45 degree, and
wherein the first filter offers total reflection to an optical signal transmitted by the Laser and gives total transmission of an received optical signal into Pin-TIA and an CATV signal, the second filter offers total reflection to an optical signal received by Pin-TIA and gives total transmission of CATV signal.

2. The OADM device according to claim 1, further comprising a third filter (4c) arranged in front of the Pin-TIA with an angle about 8 degree with respect to a the transverse direction, said third filter giving total transmission to the optical signal received by the Pin-TIA and offering total reflection of the other optical signal.

3. The OADM device according to claim 1, wherein said device can be adopted only at either User end or Office end, or can be deployed in both User's end or Office end.

4. The OADM device according to claim 1, wherein a cavity is set up on the main body at back of the first filter, which is filled with absorbance material.

5. The OADM device according to claim 1, wherein the end surface of first fiber ferrules is an inclined surface with an angle ranging from 6° to 10° with respect to the vertical direction.

6. The OADM device according to claim 1, wherein the end surface of second fiber ferrules is an inclined surface with an angle ranging from 6° to 10° with respect to the vertical direction.

7. The OADM device according to claim 1, wherein the optical Lens is either of a C-Lens or a G-lens with gradual-change refractive index and having a shape in column, and one side of the column is spherical surface and the other side is inclined surface.

8. The OADM device according to claim 7, the inclined surface of Lens 5 has an angle of 4°-8° with respect to the vertical direction.

9. The OADM device according to claim 1, one face of the first filter facing the end of Laser is coated with band rejection window for the optical signal from Laser end, the other face is coated with antireflective film in conformity with optical signal of CATV and received optical signal of Pin-TIA.

10. The OADM device according to claim 1, one face of the second filter facing the end of Pin-TIA is coated with band rejection window for the received optical signal into Pin-TIA end, the other face is coated with antireflective film in conformity with optical signal of CATV.

11. The OADM device according to claim 2, one face of the third filter facing the end of Pin-TIA is coated with a antireflective film for the received optical signal from Pin-TIA end and the other face is coated with the reflection film for other optical signal.

12. The OADM device according to claim 1, wherein the first fiber ferrule and the second fiber ferrule are symmetrical on the main body of the device.

13. The OADM device according to claim 1, wherein the first fiber ferrule and the second fiber ferrule can be fixed following with fiber pig tail or a plug-and-pull structure which like half of fiber connector, so that ready for the fiber jumper plug in.

14. An optical access network, comprising:
a CATV end for receiving a CATV signal;
a EDFA for amplifying the CATV signal received from the CATV end;
a splitter for distributing the amplified signal from the EDFA;
characterized in that, said optical access network further comprising a OADM device according to claim 1 or 2.
